(19) United States
(12) Patent Application Publication
(10) Pub. No.: US 2010/0191761 A1
(43) Pub. Date: Jul. 29, 2010

(54) APPARATUS AND METHOD FOR HANDLING TASKS OVER A COMPUTERIZED NETWORK

(76) Inventors: Aharon Avitzur, Ramat Efal (IL); Tamir Menahem, Ramat-Gan (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(21) Appl. No.: 12/665,037

(22) PCT Filed: Jun. 16, 2008
(86) PCT No.: PCT/IL2008/000820

§ 371 Date: Dec. 17, 2009

Related U.S. Application Data
(60) Provisional application No. 60/944,536, filed on Jun. 18, 2007.

(51) Int. Cl. G06F 17/30; G06F 9/46

(52) U.S. Cl. 707/769; 718/100; 707/E17.014

(57) ABSTRACT

The subject matter discloses a method of handling a computerized task, comprising receiving data related to the computerized task generating a programmable application using the data related to the computerized task. The programmable application may be a script or an executable. The computerized task may be upload or download of files, or a search query. A response is sent to the user's device or personal account. The subject matter also discloses a system for handling a computerized task, comprising a receiving device for receiving data related to the computerized task; a code generator for generating a programmable application used for performing the computerized task; and a processing element for determining a computerized application related to the computerized task.

### BACKGROUND OF THE INVENTION

1. Field of the Invention

The present invention relates to data transfer in general, and to performing tasks over a computerized network in particular.

2. Discussion of the Related Art

An open network, such as the internet, has a significant role in our life in performing tasks in the fields of shopping, entertaining, studying and the like. Such tasks may be searching for an item to purchase, uploading a file into a web application such as a social network or an FTP folder, downloading media content and the like. Nowadays, users actively browse and reach a desired web page or application, and perform such tasks. This requires time and attention from the user, which in many cases has to browse through several web pages to reach the desired web page, for example if specific parameters or values are required. Further, the user is required to understand and get familiar with new user interfaces and then wait until the task is performed, especially when downloading or uploading content. The time required for browsing and waiting for the task to end is increased when performing the tasks using wireless devices such as a PDAs or wireless phones that have limited bandwidth, processing and usability capabilities.

Other drawbacks of performing tasks in the above described method of browsing into a specific application and performing the task only upon reaching the desired web page or website are the inability to perform a task without a computer, and inability to perform the tasks without access to the open network. Further, the user is required to pay attention while performing such task, for example by browsing, purchasing, input personal data, waiting for the web application to process the inputted data, wait for upload of such data and the like. For example, a user cannot submit an upload request without browsing and consume processing resources. Further, in case a user is required to perform multiple tasks that are similar or identical, no technical solution known in the art uses the similarity of the tasks in reducing the user interactions time and the computerized resources required. Nowadays, the user cannot submit a request, close the electronic device that received the request, for example the personal computer, and receive a response or acknowledge message. The time the user spends on the task is conditioned to the web application or computerized application associated with the task.

Common solutions do not provide methods to apply the same task over several sites, simultaneously. For example, a task for sending weather query to two or more websites on the same time.

A system and method for handling tasks performed via applications on an open network is a long felt need.

### SUMMARY OF THE PRESENT INVENTION

The subject matter discloses a method of handling a computerized task, comprising receiving data related to the computerized task and generating a programmable application using the data related to the computerized task. In some embodiments, the method further comprises a step of sending the programmable application to an application related to the computerized task

The programmable application may be a script or an executable. In some embodiments, the method further comprises a step of running the programmable application. In some embodiments, the method further comprises a step of transforming the data related to the computerized task into data fields used to generating the programmable application.

In some embodiments, the computerized task relates to an internet application and the computerized task is received from an offline computerized device. In some embodiments, the computerized task is a search query. In some embodiments, the search query is an internet search query.

In some embodiments, the method further comprises a step of sending a response to the computerized task. In some embodiments, the response to the search query is a value selected from a group consisting of a date, name, price, phone number, physical address or any combination thereof.

In some embodiments, the computerized task is related to upload or download of files or text. In some embodiments, the computerized task is related to receiving data from a communication account of a user who generated the computerized task. In some embodiments, the application related to the computerized task is an offline database.

It is another object of the subject matter to disclose a system for handling a computerized task, comprising; It is another object of the subject matter to disclose a receiving device for receiving data related to the computerized task; a code generator for generating a programmable application used for performing the computerized task; and a processing element for determining a computerized application related to the computerized task.

In some embodiments, the system further comprises a sending device for sending the programmable application to a destination associated with the computerized application related to the computerized task. In some embodiments, the system further comprises a parser for parsing a message received from a user into data fields. In some embodiments, the system further comprises a matching unit for matching the data fields with predefined values and determining the computerized task.

It is another object of the subject matter to disclose a method for performing tasks on the interne in which one message is sent by a user and two or more results are provided from two or more web applications.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows a computerized environment for handling tasks on applications, according to some exemplary embodiments of the subject matter;

FIG. 2 shows a message engine for handling messages and requests from the to user's computerized device, in accordance with some exemplary embodiments of the subject matter;

FIG. 3 shows a flowchart of handling messages and requests from the user's computerized device, in accordance with some exemplary embodiments of the subject matter; and

FIG. 4 shows a flowchart in which an executable or script is used to perform a task in an application, in accordance with some exemplary embodiments of the subject matter.

### DETAILED DESCRIPTION OF THE PREFERRED EMBODIMENT

One technical problem dealt in the subject matter is to enable users to perform online tasks without browsing, or without attending web applications or web pages that provide such applications or receive content that relates to the tasks.

The technical solution comprises a message server that receives messages that contain requests or orders from the user of an electronic device. The message server converts the message into a computerized script activated on one or more applications, for example web applications, web pages, or computerized databases. The script receives one or more results from the one or more applications, or performs tasks according to the message received from the user. The message server resides between the user's electronic device, such as a PC, wireless phone, PDA and the like, and the one or more applications or databases used for performing the task or receiving data as required in the user's message. Hence, the task is not performed by the user's electronic device, while only the request is sent via the user's electronic device. This allows performing tasks on applications on the Internet without browsing, since the user sends a message request in a format such as SMS, WAP, HTML and the like to the message server that performs the task, such as a query from a database, and returns the result of the query. Further, this allows upload and download of files without browsing, while avoiding the requirement to reach a specific web page or application.

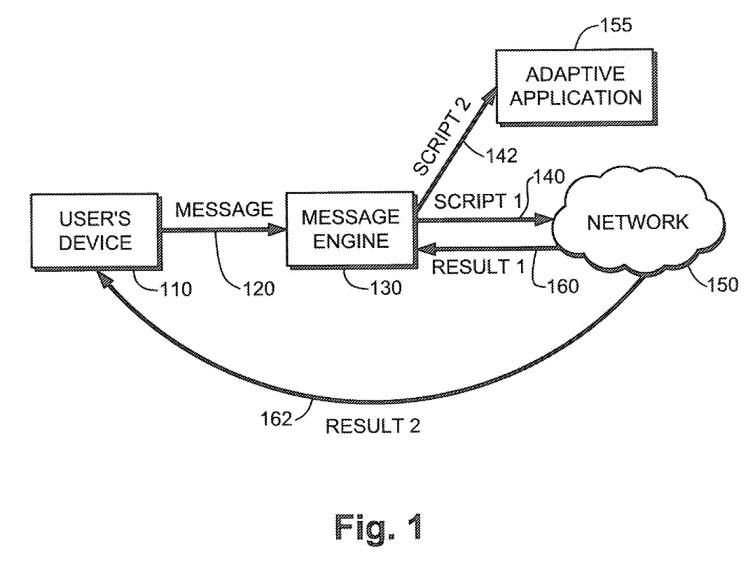

FIG. 1 shows a computerized environment for handling tasks on applications, according to some exemplary embodiments of the subject matter. The user uses computerized device 110 to send a message 120 to message engine 130. User's computerized device may be a personal computer (PC), personal digital assistant (PDA), wireless phone, wired phone, television, or any other computerized device capable of receiving a message and sending said message over a network to another device, such as message engine 130. The message 120 sent from computerized device 110 may be an email message, SMS, MMS, free text inputted by the user into computerized device, choice the user chose from a multiple choice interface that enables a variety of tasks or queries to be performed via computerized device 110. For example, the user can choose from searching the web using the mobile phone, without browsing or being online, to checking the number of new messages in her email account. Such message 120 may comprise a query from a database or a request for performing a task on a computerized application or a web application, and may comprise identifying data fields, as described below. The message 120 is received at message engine 130 and converted into computerized scripts 140, 142 to be activated on the computerized application, such as adaptive application 155 or sent to network 150, for performing a task on an application residing on said network 150. Computerized script1 140 is an example to a script activated on the internet, for example when the task desired by the user is searching the internet and providing a specific result instead of a list of links. For example, in case the message 120 is converted into script1 140, the message may contain the terms “internet, search, hotel NYC 120-150$” and a potential date. The message is converted into a script that runs one or more web pages related to hotels in New York, limits the search to the price range and available dates and returns one or more results in the result1 message 160. Result1 160 may be sent to computerized device 110 via message engine 130, or sent to a message account such as an email account or an account on a social network. Other scripts activated on the internet or other open networks such as network150 may provide downloads of content or media files from the open network. The scripts may also relate to sending a message to one or more professionals to receive price quotes, known the weather in two days or any other task that does not relate to a specific application such as adaptive application 155. The result, in both cases of result1 160, and result2 162, may contain confirmation that the task has been performed, provide one or more results according to the message 120, provide a link that shows that the task has been performed, contain a URL related to the response, or contain other data as desired by a person skilled in the art. In case a user wishes to use or perform a task related to a specific and known application, the message 120 is likely to contain the name or other metadata that identifies the application. For example, in case the user wishes to upload a media file from the computerized device 110 into the adaptive application 155 such as a movie or image database, the message 120 may contain the name of the application, the URL of the application, a link to the file to be uploaded, username and password of the user. Message 120 is then converted into script2 142 such that the script is activated on the adaptive application 155 in a similar manner to browsing of the user. Thus, the script enters the desired web page of the adaptive application 155, inputs the username and password of the user received at message 120 and performs the task on the user's behalf, while the user may be offline or perform any other task not related to the task performed by script2 142. Once the task performed by script2 142 is done, response, such as response 160 is sent to engine server or directly to the user's computerized device 110 such as response 162.

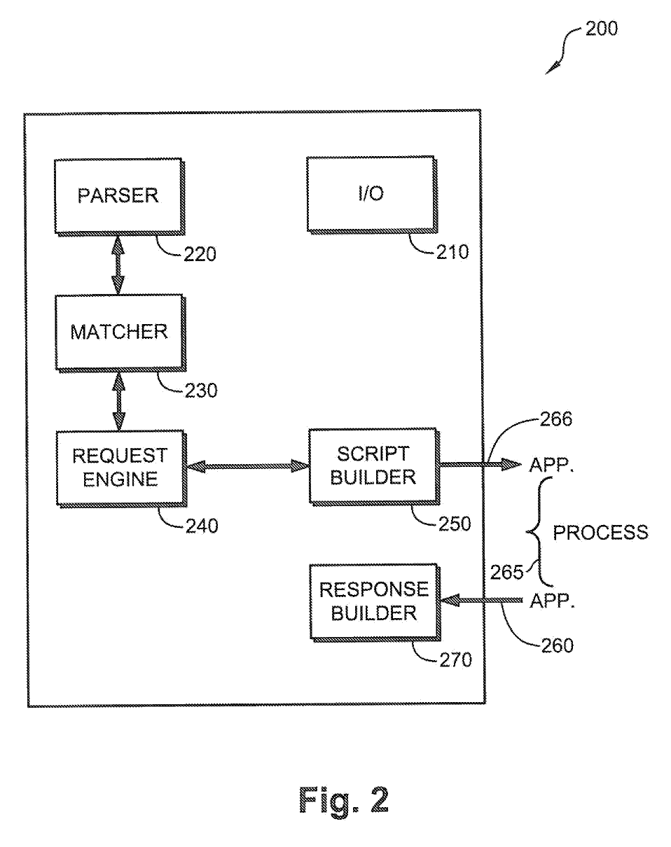

FIG. 2 shows a message engine 200 for handling messages and requests from the user's computerized device, in accordance with some exemplary embodiments of the subject matter. Message engine 200 comprises an I/O device 210, for receiving data related to the messages received from the user, transmitting data related to the scripts or executables (such as script1 140 of FIG. 1) transmitted from the message engine 200 after converted from the message (such as 120 of FIG. 1). I/O device 210 may also receive the results of the query sent by the user and transmit such result to the user's computerized device (such as 110 of FIG. 1). I/O device 210 may also receive confirmation that a specific task has been performed, without receiving the details of that task, for example the application used, or the time and resource consumed for performing the task.

Message engine 200 may also comprise a parser 220 in communication with is the I/O device 210. Such parser 220 receives the message from the I/O device 210 and preferably divides the message into data fields that can be used to build an executable file or a script. For example, the parser 220 converts the user's message into words that have meanings to a matching unit 230 that receives the parsed message or data fields. Matching unit 230 may compare the expressions or data fields with predefined data to determine the query or task within the user's message. In case the matching unit 230 does not find suitable match, it may send a message to parser 220 to reparse the user's message. Once the matching is performed by matching unit 230, the data fields are sent to a request engine 240 that converts the data fields to a request format that can be later sent to a script builder 250 to create a script or executable that performs the task or query required in the user's message. Request engine 240 inputs the parameters or data fields into predefined fields in a message later sent to the script builder. In some exemplary embodiments of the subject matter, request engine 240 also modifies at least a portion of the data fields or parameters received from matching unit 230 in order to fit the requirements of script builder 250. For example, the request sent from request engine 240 may contain the name or identity of the user, the name of the task, the number of an adaptive application, return value or any other parameter desired by a person skilled in the art. The request sent by the request engine 240 to script builder 250 may use a scripting language such as JavaScript, Vbs, Csh, Ksh, Perl and the like that can be used to invoke web services, database services or communication services.

Script Builder 250 is responsible to receive the request from the request engine 240. Script Builder 250 identifies the script language of each task or query, and generates an executable batch script. Such executable or script may comprise parameters related to a specific application, or relate to a generic application such as an online search. Script builder 250 sends the executable or script to a playing application 266 that runs the script or executable through an execution framework 265. The execution framework 265 supports execution restart, cancellation on the fly, undo functionality, multithreading, logging, monitoring and the like. Once the script or executable performed the task or reached a result of the query, the result or response to the query or request are sent to response builder 270 that sends the response to the user's device. In some exemplary embodiments of the subject matter, response builder 270 modifies the results from the script or executable before sending the response to the user' device. In accordance with some exemplary embodiments of the subject matter, the parser and matching unit reside outside the message engine. In such configuration, the data fields of the request are determined before the message is received at the message engine, which generates the executable or script, runs the script on the framework and receives the response from the script after the task is performed.

message engine 200 may use, handle, generate and analyze messages, requests, tasks, scripts and responses using applications that preferably comprise software components written in any programming language such as C, C#, C++, Java, VB, VB.Net, or the like, and developed under any development environment, such as Visual Studio.Net, Eclipse or the like. It will be appreciated that the server and the clients can alternatively be implemented as firmware ported for a specific processor such as digital signal processor (DSP) or microcontrollers, or can be implemented as hardware or configurable hardware such as field programmable gate array (FPGA) or application specific integrated circuit (ASIC).

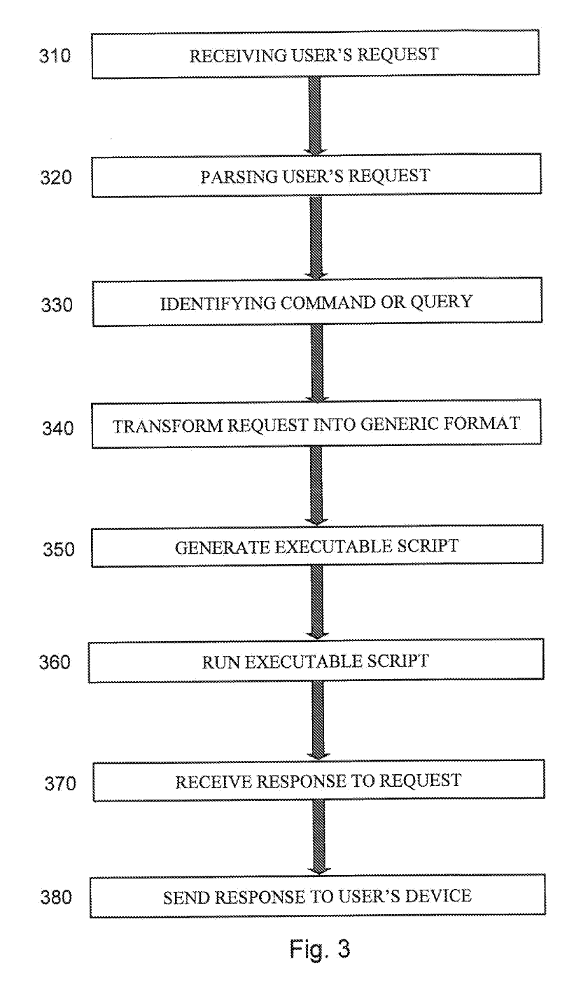

FIG. 3 shows a flowchart of handling messages and requests from the user's computerized device, in accordance with some exemplary embodiments of the subject matter. On step 310, message engine, such as message engine 200 of FIG. 2, receives a request from the user. The request may be received from a communication server (not shown) connected to the message engine. The request may be received as an email message, SMS, message sent via an instant messaging application and the like, and may be modified before received at the message engine to fit a predefined format. On step 320, the user's request is parsed, such expressions in the message are retrieved. In some exemplary embodiments of the subject matter, the request is divided into two or more data items stored in the message engine for further processing. On step 330, a command, task or query is identified from the user's request. Such identification may be performed using predefined expressions and tasks stored in the message engine and compared to data items parsed from the user's message. In accordance with some exemplary to embodiments of the subject matter, the step of parsing is performed before the request is received at the message engine. On step 340, the user's request is converted into a generic format. Such generic format may contain the name of the application using which the task is to be performed, the type of the task, and the like. In some cases, at least one of the data fields related to the task should be filled after the step of identifying. Otherwise, content server may send a message to the parser or the matching unit to reparse or retry to identify the task. On step 350, after the identified data fields are sent to the script builder 250, the executable or script are generated. The script may be generated on the message engine or at least partially using the application. For example, in case the task sent by the user refers to finding a hotel in New York that relates to a specific firm, the script generated by the message engine finds the web application of the specific firm, while another script, generated by the specific firm, finds the hotel room according to parameters inputted by the user. On step 360, the script or executable runs. The script may be used on the entire open network, or only on specific application, an online application or a database connected to the message engine. The script may provide search result without browsing, or provide an answer to a question according to the user's message, instead of a list of links as known in the art. Such executables may run on software applications, and may be ready before the user's request, and only few values to be inputted into a data field for generating the script or executable. For example, the message engine may provide for an upload task, for uploading files or texts onto a server or application, either on the internet or on another computerized entity connected to the message engine. Hence, the user need only input the name or URL of the application, the name or link to the file, and the script is generated, retrieves the file or text from the user's device and sends it to the desired application. In other cases, search is the task desired by the user. Such search may be adaptive, for example in finding specific goods or services, and may be general, for example a query for receiving the population of a specific city. In case the query is general, the script looks for an application or database related to the query, for example a website of the city related to the search query, and looks for the number cited as the population. In case the search is narrower, the script goes to an application related to the specific field, such as tourism, finds one or more results, and sends a response, as shown on step 370. Such executable or scripts are commercially available. One of the technical effects of the subject matter is the use of such scripts without browsing, or even when the user's device is OFF, using the message engine and the method disclosed herein. Another technical effect is to provide direct results instead of a list of links. Such direct results are provided in a manner that the user avoids further browsing. The response to the query may be a value, for example in case of a search query, or a confirmation that the task has been performed, for example on an upload or download task. On step 38-, the response may be sent to the message engine, to the user's device, or to a communication account of the user, such as an email account or a voice mail account.

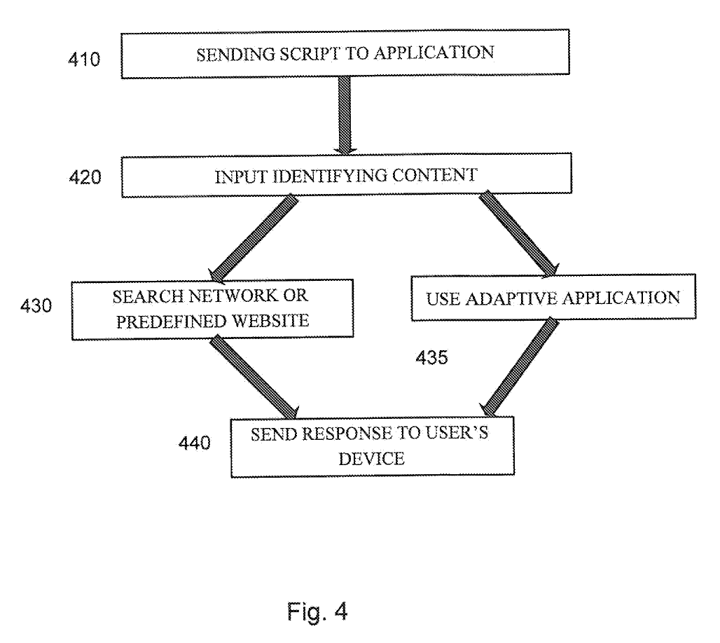

FIG. 4 shows a flowchart in which an executable or script is used to perform a computerized task in an application, in accordance with some exemplary embodiments of the subject matter. On step 410, the executable or script are sent from the message engine to a computerized entity that contains the application related to the task. Such application may be a web page, an offline database, communication account and the like. The computerized entity may be any server or computer that stores the application or metadata related to the application. On step 420, the script or executable sends identifying content to the application. Such identifying content may be username and password or metadata related to the user who sends the message later transformed into the task performed using the script or executable. The step of sending identifying content is preferably used when the task relates to a specific application in which the user holds an account, or an institution or organization associated with the user holds an account. Such applications may be email account, an application for uploading or downloading content, voice mail account and the like. More specifically, such applications may perform similar functionalities to YouTube, Flicker and the like. In case the script or executable performs a general search query as the task, the step of identifying may not be required. In case of performing a search on a specific internet web site, or on the entire network, step 430 is performed, in which keywords and/or web pages inputted by the user are used to provide direct results. For example, the user may send a query for the winner of a specific competition. Next, the script may enter web pages related to the specific competition and determine the winner of the desired year or contest, and send the result to the user or to the message engine. Step 435 discloses a case of using a specific application, either web application or offline application, for handling text or files. For example, the user may wish to receive lyrics of a specific song. Hence, the script may look for an adaptive application previously determined by the user, look for the song and receive the lyrics. Other adaptive applications may disclose uploads and downloads or files, checking the email account status, add friends to a social network and the like. In accordance with some exemplary embodiments of the subject matter, the steps of download or upload content or files or updating status in a web application are at least partially performed by the script or executable while the user's computerized device may be offline or even OFF.

In some exemplary embodiments, the user sends one message to the message engine. The message engine sends the script or executable generated from the user's message to several web applications, and receive two or more results. This may provide the user with more results for the same query or request. Further, the two or more results may be provided in different tabs in the same browsing window. Alternatively, a text result is provided instead of a link or a URL, and each result is associated with a different source. Alternatively, one result may be provided from different sources, using a mathematical or logical function or manipulation on the data received from each web application of the two or more web applications.

In accordance with some exemplary embodiments of the subject matter, the message engine comprises an interface that allows the user to determine a specific application to be used by the script for sending or receiving content or files. For example, uploading a specific file into a web application listed on the user's device. The message engine can receive the identifying content when the user subscribes at the engine, or from the application.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method of handling a computerized task, comprising:
receiving data related to the computerized task;
generating a programmable application using the data related to the computerized task.

2. The method according to claim 1, further comprising a step of sending the programmable application to an application related to the computerized task.

3. The method according to claim 1, wherein the programmable application is a to script.

4. The method according to claim 1, wherein the programmable application is an executable.

5. The method according to claim 2, further comprising a step of running the programmable application for executing the computerized task.

6. The method according to claim 1, further comprising a step of transforming the data related to the computerized task into data fields used to generating the programmable application.

7. The method according to claim 1, wherein the computerized task relates to an internet application and the computerized task is received from an offline computerized device.

8. The method according to claim 1, wherein the computerized task is a search query.

9. The method according to claim 8, wherein the search query is an internet search query.

10. The method according to claim 5, wherein running the programmable application is performed before sending the programmable application to a URL for executing the task.

11. The method according to claim 10, wherein the response to the search query is a value selected from a group consisting of a date, name, price, phone number, physical address or any combination thereof.

12. The method according to claim 1, wherein the data related to the computerized task is a URL address.

13. The method according to claim 1, wherein the computerized task is related to receiving data from a communication account of a user who generated the computerized task.

14. The method according to claim 1, wherein the application related to the computerized task is an offline database.

15. A system for handling a computerized task, comprising;
A receiving device for receiving data related to the computerized task;
a code generator for generating a programmable application used for performing the computerized task;
a processing element for determining a computerized application related to the computerized task.

16. The system according to claim 15, further comprises a sending device for sending the programmable application to a destination associated with the computerized application related to the computerized task.

17. The system according to claim 15, further comprises a parser for parsing a message received from a user into data fields.

18. The system according to claim 15, further comprises a matching unit for matching the data fields with predefined values and determining the computerized task.

19. A method for performing tasks on the interne in which one message is sent by a user and two or more results are provided from two or more web applications.
